(19) United States
(12) Patent Application Publication
(10) Pub. No.: US 2002/0024676 A1
(43) Pub. Date: Feb. 28, 2002

(54) Position detecting device and position detecting method

(76) Inventor: Yasuhiro Fukuzaki, Saitama (JP)

Correspondence Address: WELLS ST JOHN ROBERTS GREGORY AND MATKIN, SUITE 1300, 601 W FIRST AVENUE, SPOKANE, WA, 992013828

(21) Appl. No.: 09/932,510

(22) Filed: Aug. 17, 2001

(30) Foreign Application Priority Data
Aug. 23, 2000 (JP) 2000-253026

(51) Int. Cl. G01B 11/14

(52) U.S. Cl. 356/623

(57) ABSTRACT

For providing an optical digitizer without expensive parts and for minimizing the device, a variation timing of an output of a linear image sensor in an optical unit is detected as a time data by using a comparator. A variation timing measuring circuit detects a variation timing of the output of the comparator. A pointed position of a position pointing device is detected from the output of the variation timing measuring circuit by obtaining an incident angle of light or shadow from the position pointing device to the optical unit.

### RELATED APPLICATIONS

This application relates to and claims a priority from corresponding Japanese Patent Application No. 2000-253026 filed on Aug. 23, 2000.

### BACKGROUND OF THE INVENTION

1. Field of the Invention

The present invention relates to an optical digitizer, and more particularly to an optical digitizer in which a structure thereof is made simple by eliminating an A/D converter, an arithmetic processing circuit and a memory circuit.

2. Description of the Related Art

Recently, a position detecting device is proposed, in which coordinates of a pointed position are calculated by the principle of triangulation so that angles of entering light from a position pointing device are detected at two positions using the light. Such position detecting device using the light is generally called an optical digitizer. In such system, a planer sensor for detecting coordinates is unnecessary and, from the viewpoint of principle, a pointed position of the position pointing device can be detected only by producing a film of light. Therefore, specifically, where the optical digitizer is combined with such display device as a liquid crystal display, it does not influence a display performance of the display device, unlike a resistance film type input device used widely. Thus, attention is being focused on the optical digitizer as an interactive input device (in which input plane and output plane are unified).

In the optical position detecting device, there are roughly three systems of obtaining a light signal for detecting the position of the position pointing device. One is that an emitting element such as a Light Emitting Diode (LED) is provided to the position pointing device itself. Another is that a light source such as an LED is provided to an optical unit of the position detecting device side, and a retroreflective member reflecting light therefrom is provided to the position pointing device. The other is that a light source is provided to an optical unit, a frame having a retroreflective member is provided to a peripheral portion of a position detecting surface of the position detecting device, and the position pointing device intercepts the light. Because the functions required by each position pointing device of each system are different, in the present specification, the three systems are called a pointing device emitting system, a pointing device reflecting system, and a pointing device intercepting system, respectively.

A system in which an optical unit does not have a light source, and a peripheral frame itself emits can also be thought of. However, it is generally difficult to obtain a linear emitting element having a uniform light emitting portion, so that a retroreflective system of a simple point-source light is used in many cases. In the present specification, the system in which the peripheral frame itself emits is also included in the pointing device intercepting system.

The method of pointing device intercepting system is disclosed in the Japanese Patent Application Kokai Publication No. Sho 62-5428. In the pointing device reflecting system, an example system in which a laser light beam is used as the light source, in which the light beam is scanned by a rotated mirror, and in which a single light receiving portion is used at a light receiving portion, is disclosed in the Japanese Patent Application Kokai Publication No. Hei 2-116917. Also, in the pointing device intercepting system, an example system in which a laser beam is used as a light source, and in which a polygon mirror and a single light receiving portion is used, is disclosed in the Japanese Patent Application Kokai Publication No. Hei 11-85376. In the above systems using the scanning laser beam, the light receiving element is a single element, and signals varying with time are detected time-wise by an A/D converter or comparator, with an actual physical beam scan.

Such laser light source is not favorable for end users because the laser light source is expensive or dangerous in some usage. Therefore, the Japanese Patent Application Kokai Publication No. Hei 9-319501 discloses a system in which an LED is used as a light source and a PSD (Position Sensing Device) is used at a light receiving side so that operating portion is dispensed with. However, in the case where the PSD which forms one light receiving surface in the whole is used as in the above system, it is difficult to raise detecting resolution.

Therefore, the applicant the same as in the Japanese Patent Application corresponding to the present application discloses in the Japanese Patent Application No. Hei 11-164123 (Japanese Patent Application Kokai Publication No. 2000-353048) that a device in which a plurality of individual light receiving elements are disposed in one-dimensional direction, i.e., a linear image sensor, is used.

In at case, light is not in a beam form, but in a fan-shaped film form. The light is simultaneously received at many light receiving elements. At a generally linear image sensor, an output signal of each light receiving element is output in time sequence to obtain its output signal. In this case, the output signal varying with time is used only for taking the output signal.

In the Japanese Patent Application No. 2000-79922 filed by the applicant the same as in the Japanese Patent Application corresponding to the present application, such output signal from the linear image sensor is converted to the digital value by an A/D converter, and then the digital signal is received by an arithmetic device so that a light incidence angle is obtained. By doing so, even if light edges are blurred, or light intensity at a background is not uniform, the light incidence angle can be calculated in a high precision. Further, more angular resolution than that obtainable from actual pixel numbers can be obtained by interpolating signal levels between pixels.

However, for example, in the case where 3000 pixel sensors are used as two linear image sensors disposed at right and left side respectively, and one A/D converter is used for sampling at a velocity of 100 times per second, the sampling speed at a velocity of six hundred thousand (which results from 2×3000×100) times per second is necessary. Further, the arithmetic device receives the above data, and only two numbers representing each light incidence angle are calculated. However, a high speed arithmetic processing device is necessary because huge data are processed. Along with this high speed operation, a high speed and mass storage memory device is also necessary.

Such high speed A/D converter, arithmetic device and memory are all expensive. Also, recently, there are many demands for the miniaturization of the device.

### SUMMARY OF THE INVENTION

An object of the present invention, therefore, is to overcome the problems existing in the prior art, and to provide an optical digitizer which does not use expensive parts, and can miniaturize the device. Timing when an output of a linear image sensor is varied is detected as time data by using not an A/D converter but a comparator.

According to one aspect of the invention, there is provided a position detecting device for detecting a pointed position of a position pointing device having a light emitting means or a shadow generating means, comprising: a flat board having a position detecting area which defines a range where the position pointing device can be moved by an operator on the flat board; and optical units disposed at least at two positions adjacent to the position detecting area of the flat board, and detecting the pointed position of the position pointing device by the principle of triangulation using light, each of the optical units comprising: a one-dimensional light receiving element array having a plurality of light receiving elements; a sequential output circuit outputting sequentially an analog value of an output of the one-dimensional light receiving element array; a clock circuit supplying a timing signal to the sequential output circuit; an output level comparing circuit judging whether the output from the sequential output circuit is higher or lower than a predetermined voltage level, and converting the analog value into a digital timing signal; and a variation timing measuring circuit for obtaining a variation timing of the output level comparing circuit, the pointed position of the position pointing device being detected from the output of the variation timing measuring circuit of each of the optical units by obtaining an incident angle of light or shadow from the position pointing device to each of the optical units.

The output level comparing circuit is provided so as to be sensitive to the incident light, and the output of the variation timing measuring circuit corresponds to the incident angle of the light, so that the position pointing device of a pointing device emitting system can be detected.

Further, a light source means is provided adjacent to each of the optical units, and the position pointing device is provided with a retroreflective means for retroreflecting the light from the light source means, so that the position pointing device of a pointing device reflecting system can be detected.

Still further, a light projecting frame which projects the light directly or indirectly is provided to a peripheral portion of the position detecting area, the position pointing device has an intercepting function for intercepting the light from the light projecting frame, the output level comparing circuit is provided so as to be sensitive to the incident shadow generated by the position pointing device, and the output of the variation timing measuring circuit corresponds to the incident angle of the shadow, so that the pointed position can be detected in a pointing device intercepting system.

Moreover, a light source means is provided adjacent to each of the optical units, and the light projecting frame is a retroreflective frame for retroreflecting the light from the light source means, so that the light source can be a simple point light source.

The variation timing measuring circuit is provided to detect both a start timing and an end timing of the light or the shadow to be detected, so that the center of the light or the shadow is calculated from both the timings.

Also, the variation timing measuring circuit repeatedly detects the light or the shadow to be detected, so that a plurality of the pointed positions are calculated.

Furthermore, a low-pass filter circuit is provided between the sequential output circuit of the one-dimensional light receiving element array and the output level comparing circuit, and a measuring time resolution of the variation timing measuring circuit is set to be higher than a clock period of the clock circuit supplying the timing signal to the sequential output circuit, so that the higher angle resolution than that obtainable from the pixel number of the one-dimensional light receiving element array can be obtained.

### BRIEF DESCRIPTION OF THE DRAWINGS

The above and other objects, features and advantages of the present invention will be apparent from the following description of preferred embodiments of the invention explained with reference to the accompanying drawings, in which:

FIG. 1 is a schematic structural view of an optical digitizer according to the invention;

FIG. 2 is a perspective view of a view field pattern of a fan shape at a light receiving element array and lens according to the invention;

FIG. 3 is a diagram showing a position pointing device having a light emitting portion according to the invention;

FIG. 4 is a diagram showing a structure of a pointing device emitting system according to the invention;

FIG. 5 is a side sectional view of a structure of the pointing device emitting system according to the invention;

FIG. 6 is a diagram showing a detecting circuit of the pointing device emitting system according to the invention;

FIG. 7 is an operational timing chart of the detecting circuit of the pointing device emitting system according to the invention;

FIG. 8 is a diagram showing a position pointing device having a reflecting portion according to the invention;

FIG. 9 is a structural view showing an optical unit of a pointing device reflecting system according to the invention,

FIG. 9A being a plan view of the optical unit,

FIG. 9B being a cross sectional view of the optical unit;

FIG. 10 is an entire structural view of the pointing device reflecting system according to the invention;

FIG. 11 is a side sectional view of an entire structure of the pointing device reflecting system according to the invention;

FIG. 12 is an entire structural view of a pointing device intercepting system according to the invention;

FIG. 13 is a side sectional view of an entire structure of the pointing device intercepting system according to the invention;

FIG. 14 is a diagram showing a detecting circuit of the pointing device intercepting system according to the invention;

FIG. 15 is an operational timing chart of the detecting circuit of the pointing device intercepting system according to the invention;

FIG. 16 is a diagram of the detecting circuit which can detect a plurality of positions in the pointing device intercepting system according to the invention;

FIG. 17 is an entire structural view in the case of detecting a plurality of positions in the pointing device intercepting system according to the invention;

FIG. 18 is an operational timing chart of the detecting circuit which can detect a plurality of positions in the pointing device intercepting system according to the invention;

FIG. 19 is a diagram of the detecting circuit having higher detecting resolution according to the invention;

FIG. 20 is an operational timing chart of the detecting circuit having higher detecting resolution according to the invention; and

FIG. 21 is a diagram for explaining a method of calculating pointed coordinates of the position pointing device by the principle of triangulation.

### PREFERRED EMBODIMENTS OF THE INVENTION

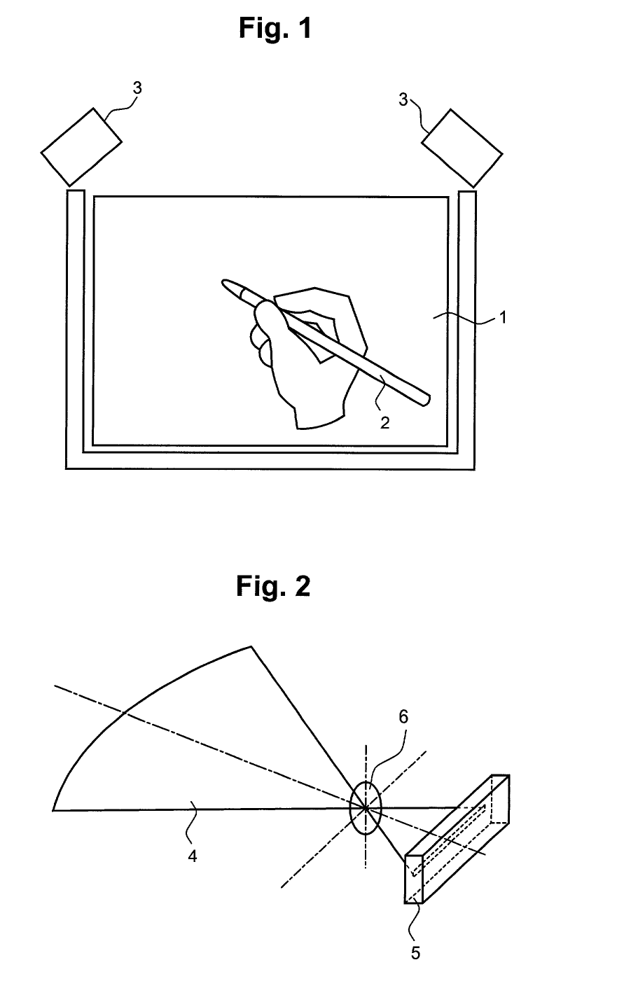

Now, a first embodiment according to the invention is explained with reference to the drawings. FIG. 1 is a schematic view of a structure of a position detecting device according to the invention. As shown in FIG. 1, a generally rectangular position detecting area 1 is provided. A position pointing device 2 is moved within the position detecting area 1 by an operator. Two optical units 3 are disposed across one side of the rectangle of the position detecting area 1. Each of the optical units 3 is fixed to have a view field angle which can survey the whole position detecting area 1. The position detecting device generally consists of the two optical units 3 and the position pointing device 2 positioned on the position detecting area 1.

First, the explanation is made on a position pointing device emitting system which is the simplest in structure. FIG. 2 shows that a fan-shaped view field pattern 4 is formed by combining a one-dimensional light receiving element array 5 with a lens 6. The one-dimensional light receiving element array 5 is constituted by which a plurality of unit elements that can detect light are disposed in a line. The fan-shaped view field pattern 4 is formed by locating the lens or slit 6 at an appropriate position of a front side (which is a light receiving direction) of the one-dimensional light receiving element array 5. The view field or the light receiving pattern 4 shown in the figure means an area in which, when the position pointing device 2 having a light emitting portion exists therein, an image is created at the one-dimensional light receiving element array 5 through the lens or slit 6 so that the position pointing device 2 can be detected.

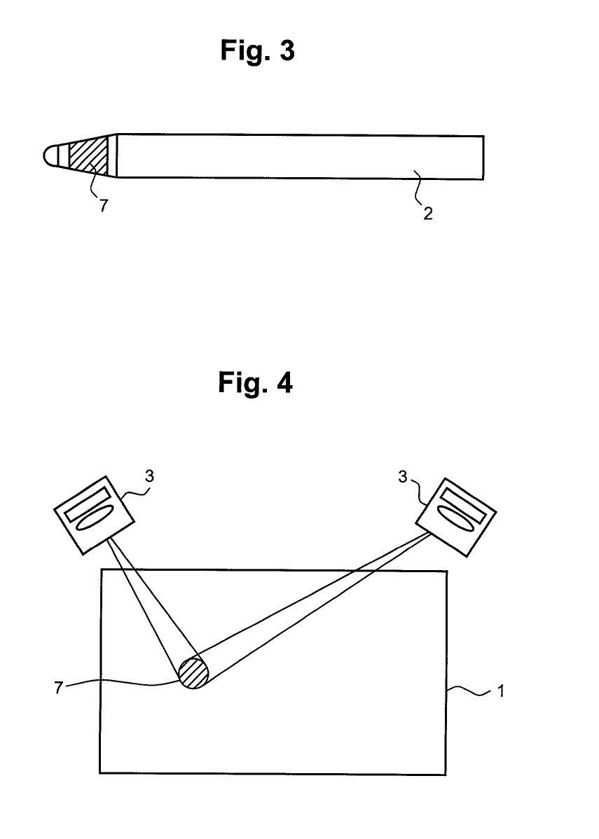

An example of a pen-type position pointing device 2 having the light emitting portion 7 is shown in FIG. 3. The term “pen-type” means that the device has a similar form of writing implements, is held by the operator's hand in the same way as a pen, and can be used to input by operating with a similar feeling of writing characters or drawing pictures on a paper using a pen. The light emitting portion 7 is provided to a portion near to the pen tip. A light source such as an LED and a necessary power source are loaded inside the light emitting portion 7, and the light emitting portion 7 emits light in case of necessity. The light emitting portion 7 is disposed at a portion sufficiently near to the pen tip so that the light emitting portion 7 is not shaded by fingers when the operator holds the position pointing device with the fingers. The position detecting area 1 in which the operator operates the position pointing device 2 is preferably arranged such that a feeling of operating the position pointing device by the operator is made similar to that of writing characters on a paper so that the position detecting area 1 is actually constituted by a flat board or a plane surface of a screen such as a liquid crystal display device. The plane surface is one with which the pen tip of the position pointing device 2 is in contact. The view field 4 of the light receiving element array 5 shown in FIG. 2 exists in plane form extending in parallel with the plane surface 1 a little above the plane surface 1. From this meaning, the light emitting portion 7 of the position pointing device 2 is provided to a portion near to the pen tip of the position pointing device 2.

FIG. 4 shows an arrangement plan view of the two optical units 3 and the position pointing device 2. This figure will be a plan view when the position detecting area 1 is assumed to be horizontally disposed. This figure, however, will be an elevational view when the position detecting area 1 is assumed to be vertically disposed as in a chalkboard. As shown in FIG. 4, the light emitted from the light emitting portion 7 of the position pointing device 2 is detected by the two optical units 3, and the incidence angle of the light is obtained so that it is detected where the position pointing device 2 exists on the position detecting area 1.

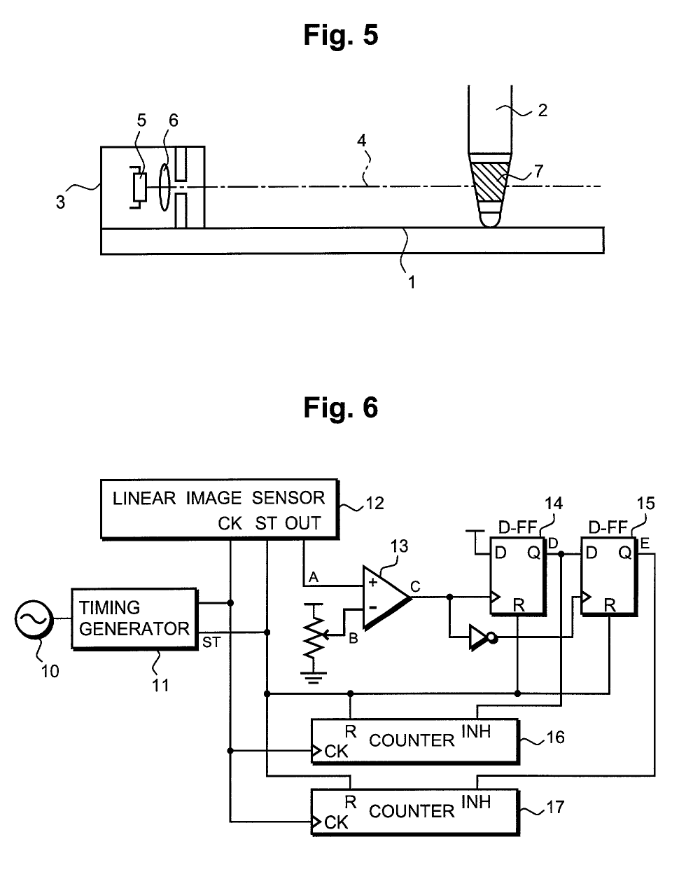

FIG. 5 is a side sectional view of the position detecting device. The one-dimensional light receiving element array 5 and the lens 6 (or the slit) explained above are provided into the optical unit 3. In FIG. 5, the view field 4 formed by the optical system is shown in one speck chain line. The view field 5 extends in parallel with the flat board defining the position detecting area 1. The light emitting portion 7 of the position pointing device 2 is positioned on the view field 4. The light emitting portion 7 may be made to emit by turning on the switch through the detection that the pen tip is in contact with the position detecting area 1. The light emitting portion 7 may also be made to emit by the switch operated by the operator.

FIG. 6 is a circuit diagram showing a central portion of the structure according to the invention. A reference clock signal generated from an oscillator (clock circuit) 10 is input to a timing generator 11. The timing generator 11 outputs an output clock signal CK and an output start pulse ST for a linear image sensor 12. The clock signal is also shared with a count clock signal of a counter 16 and a counter 17. The output start pulse ST is also used as a reset signal of the counter 16, the counter 17 and D-FFs (D-type Flip-Flop) 14, 15. An output signal OUT of an analog value from the linear image sensor 12 is converted to a digital signal at a comparator 13. In this case, a reference voltage is adjustable. An output C of the comparator 13 is input to a clock terminal of the D-FF 14. An output D of the D-FF 14 is input to a count inhibit input terminal of the counter 16, and an output E of the D-FF 15 is input to a count inhibit input terminal of the counter 17.

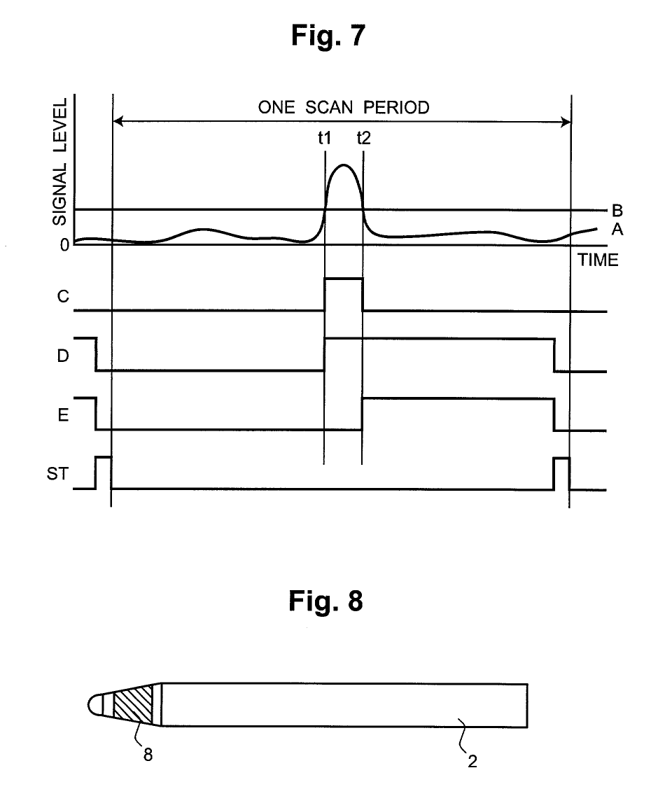

A variation of each signal of the circuit in FIG. 6 is shown in FIG. 7. In this case, it is described for purposes of explanation that the output of the linear image sensor 12 is high when bright, and the digital signal becomes the positive logic. One time scan output appears depending on the output start pulse ST with the clock signal continuously supplied. At this point, the two counters 16, 17 are reset, and begin the count operation. Then, the signal A from the linear image sensor 12 is compared with the reference level B by the comparator 13. When the signal A exceeds the reference level B at a timing t1, the output C of the comparator becomes 1, and when the signal A falls down beyond the reference level B at a timing t2, the output C of the comparator returns to 0. At this time, as the output C is input to the input clock terminal of the D-FF 14, the signal D becomes 1 at the timing tl and the count inhibit input of the counter 16 becomes 1, so that the counter 16 stops at the timing t1. Then, since the output E of the D-FF 15 becomes 1 at the timing t2, the counter 17 also stops at the timing t2.

By doing so, two counter values which indicate a start and an end of angles of the incident light are obtained. Here, for easily calculating the center angle of the light incidence angle, the two counter values may be added together and the result is divided by 2. As the difference in the two counter values also indicates a width of the shadow, it is also possible to make discrimination as to kinds of a finger or a pen in accordance with the difference in values. In this case, first, a position of the pointing device 2 is detected, and the width of the shadow needs to be compensated with the distance from the optical unit 3. Such adding circuit and dividing circuit by 2 (a shift circuit), and a subtracting circuit are also constituted by hardware easily.

The signal from another optical unit 3 is similarly processed. Since each of directions of the pointing device 2 from the two optical units 3 is obtained, the position of the pointing device 2 can be calculated from the two angle data.

In this example, the structure is one in which the two counters are used and the counts are stopped at a predetermined timing. However, the structure may well be one in which, for example, one counter is used and two latches are used, and count values are latched at a predetermined timing.

Next, an embodiment of the pointing device reflecting system is explained. An example in which a retroreflective material 8 is provided on a pen-type position pointing device 2 is shown in FIG. 8. A point different from the position pointing device in FIG. 3 is that the light emitting portion 7 in FIG. 3 is a retroreflective material 8 in FIG. 8. The term “retroreflection” means a characteristic in which the incident light from anywhere optically is made to return straight back to where it came from. As to the retroreflective material, a sheet-form material in which, for example, transparent beads are buried is sold by 3M Company, etc.

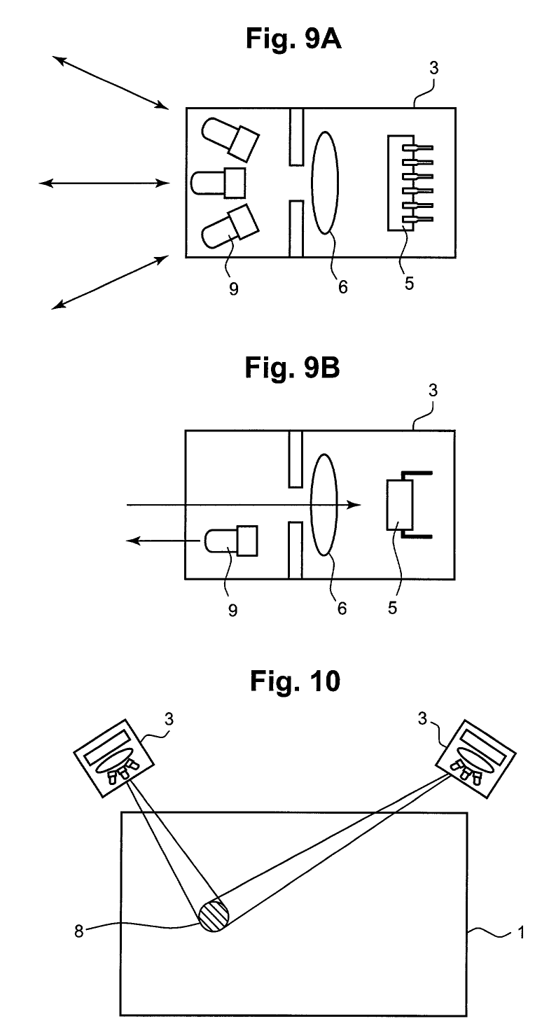

The structure of the optical unit in the case of the position pointing device having the retroreflective portion is shown in FIG. 9. FIG. 9A shows a plan view of the optical unit 3. A plurality of light emitting diodes 9 are provided, and cover the fan-shaped view field of the one-dimensional CCD 5. FIG. 9B shows a cross sectional view of the optical unit 3. The light emitting diodes 9 are positioned where the incident light to the one-dimensional CCD 5 is not disturbed. As explained, the light emitting diodes 9 are provided and are made to emit light to the pointing device 2.

FIG. 10 is a plan view showing a structure of the position detecting device in the pointing device reflecting system. Points different from the structure of the light emitting system shown in FIG. 4 are that the light emitting diodes 9 are provided in the optical unit 3 and the retroreflective portion 8, not the light emitting portion, is provided at the position pointing device 2.

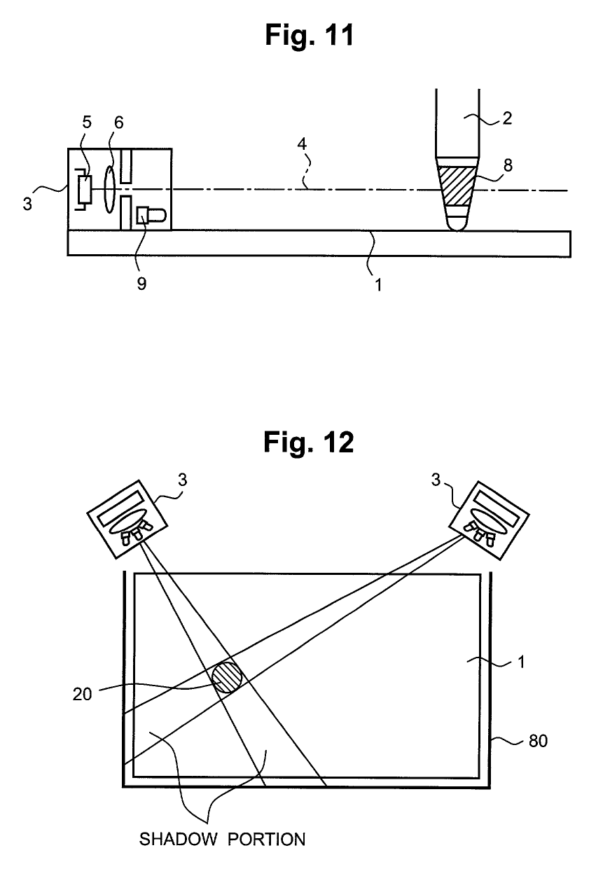

A side view of the structure of the pointing device reflecting type position detecting device is shown in FIG. 11. FIG. 11 is generally the same as FIG. 5. The structure of the signal processing circuit is also the same as that in FIG. 6. Since the appearance of the light peak is the same, the waveform of the signal which is the same as that in FIG. 7 can be obtained. Therefore, the position detection can be conducted by the same process as above.

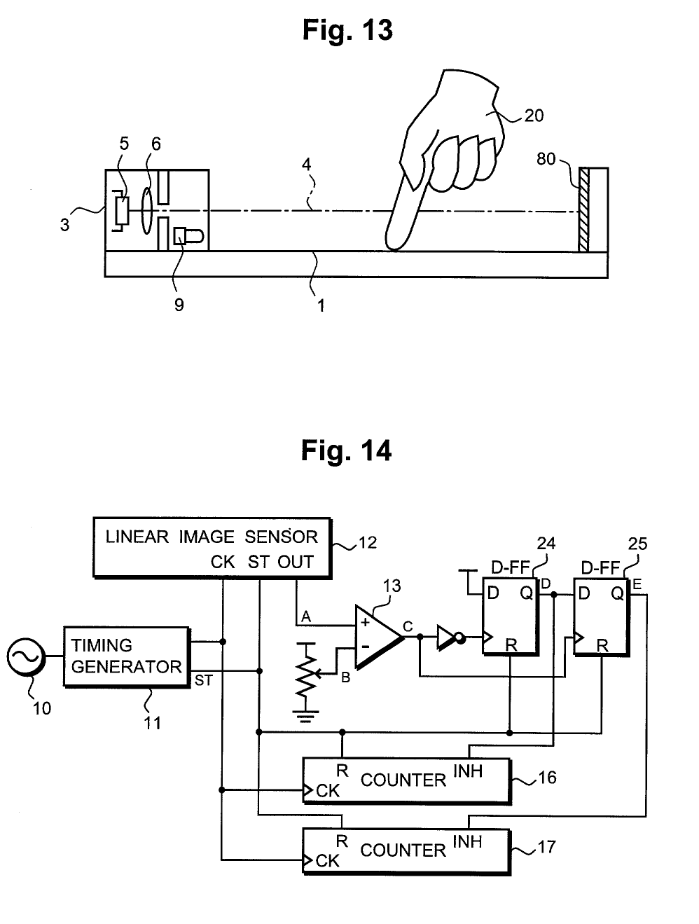

Next, an embodiment of the pointing device intercepting system is explained. The structure of the optical unit 3 is equivalent to that of the pointing device reflecting system, and the light source 9 is provided in the optical unit 3. The structural example of the pointing device intercepting system is shown in FIG. 12. A retroreflective frame 80 is provided at a peripheral portion of the position detecting area 1. As shown in FIG. 13, the position pointing device in this case may be a finger 20 of human. In this case, the light from the retroreflective frame 80 is intercepted by the pointing device 20, so that the shadow is generated. Therefore, the reflection from the pointing device 20 to the optical unit 3 is desirably little.

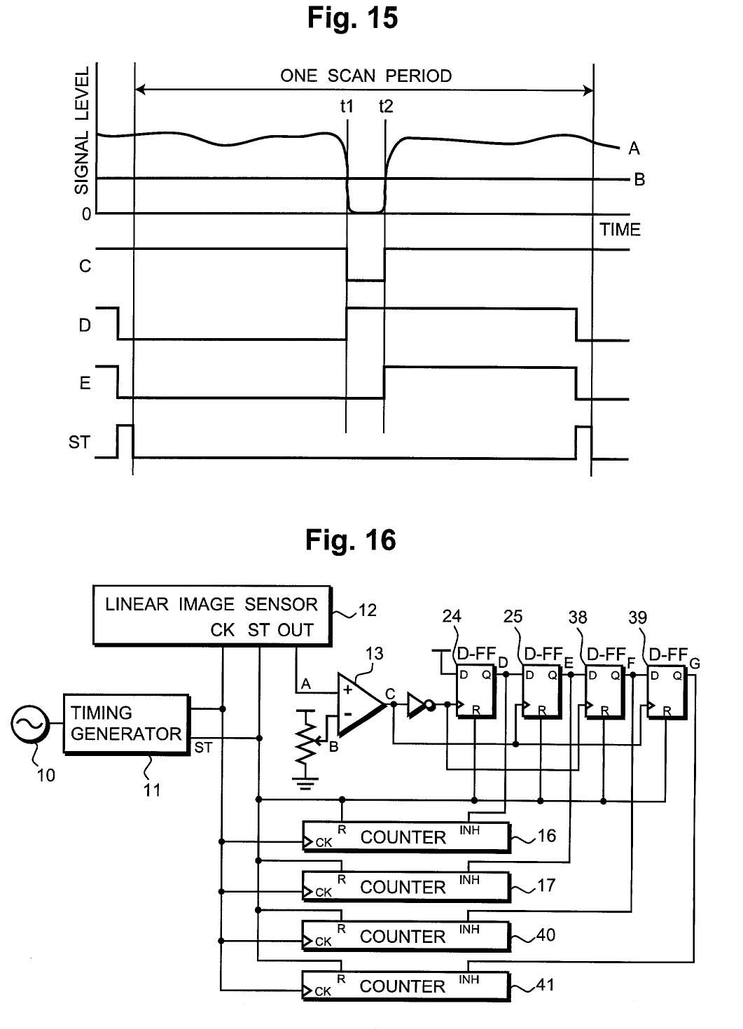

An example of the signal processing circuit in the pointing device intercepting system is shown in FIG. 14. FIG. 15 is a timing chart of the signal in the case of this circuit. As contrasted with the pointing device emitting system or the pointing device reflecting device, a shadow portion, i.e., a valley portion of the output signal is detected. Therefore, the clock signals to a D-FF 24 and a D-FF 25 are inversed as compared with those in FIG. 6. The other operations are the same as those in the pointing device emitting system.

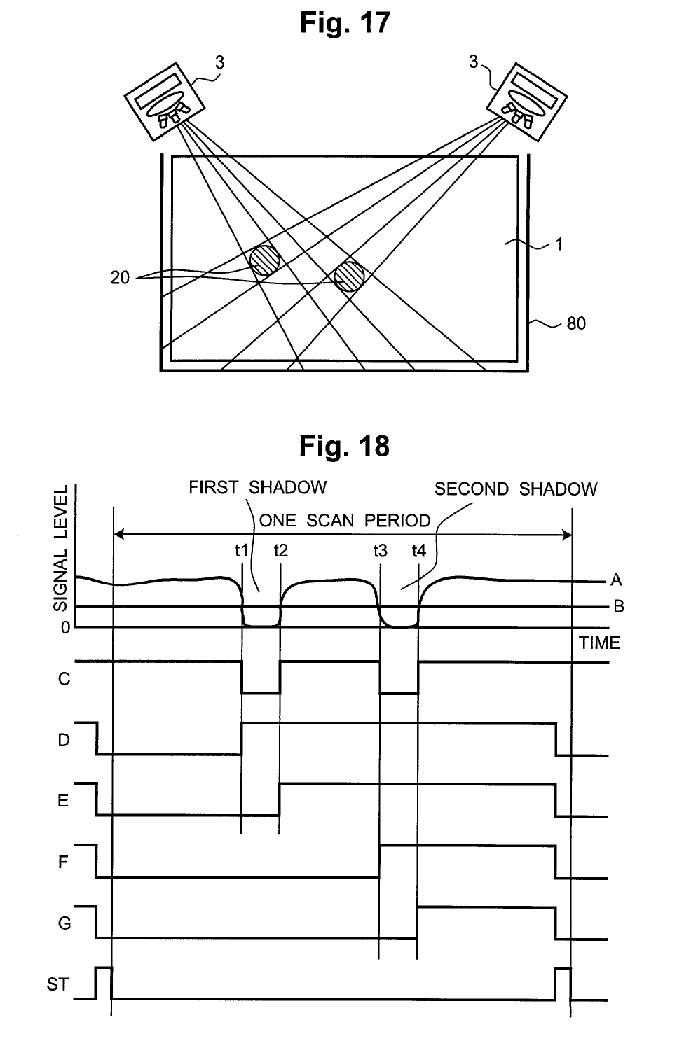

FIG. 16 shows an example of a detecting circuit which can also detect an incidence angle of the second shadow. An example in the case where there are two objects to be detected is shown in FIG. 17, and a timing chart of each signals in this case is shown in FIG. 18. The operations until the first two D-FFs 24, 25 are the same as in the example in FIG. 14. A third D-FF 38 and a fourth D-FF 39 are operated by the second shadow. Therefore, the incidence angle of the second shadow is obtained from the rear two counter values.

This operation is conducted at the right and left optical units 3, and the pointed position is calculated from the respective detected angles. In this case, two combinations of the calculated coordinate positions are generated. However, the pointed position can be determined by adding the restrictions (the rule on the operation) such that the fingers are arranged side by side.

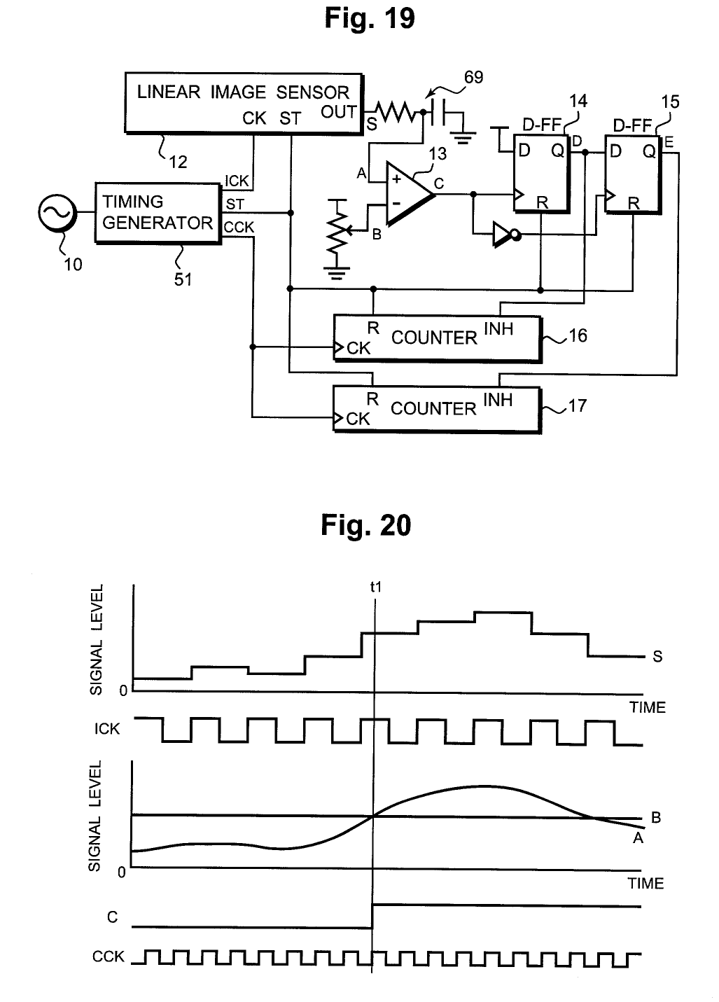

An example in which a low-pass filter circuit 69 is installed in front of the input of the comparator 13 is shown in FIG. 19. The timing chart in this case is shown in FIG. 20. The time axis of horizontal in FIG. 20 is expanded compared with the above-explained timing chart. Since the output from each light receiving element 12 is sequentially output in synchronization with the clock ICK from a timing generator 51, the output of the image sensor 12 is in a form of a stair-like waveform represented by S. This waveform is made to be a waveform represented by a signal A which is gentle variation by removing the high-frequency component through the low-pass filter circuit 69. This signal becomes an analog signal pseudo-interpolated between variation points of the original stair-like waveform. This signal is input to the comparator 13, and the frequency of the counter clock CCK from the timing generator 51 into the counters 16, 17 which are stopped by the variation timing of the comparator output is made high, so that the angle data can be obtained with higher resolution than in the pixel number of the image sensor.

Here, the waveform of the signal S is the complete stair-like waveform for the explanation. However, there is a case where the similar signal to the signal A is observed without installing the specific low-pass filter circuit because of a slew rate of an output circuit of the image sensor or an impedance of lines. However, in this case, the essence is the same as the present invention. The low-pass filter circuit 69 shown in FIG. 19 is the simplest structure. However, it goes without saying that the other structures are also usable.

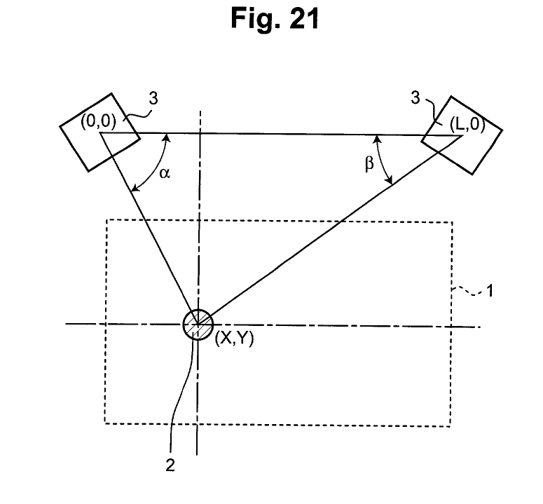

The method for calculating position coordinates of the position pointing device by the principle of triangulation is shown in FIG. 21. The angles α and β are measured when the position pointing device 2 is detected by the optical unit 3. Where a distance between the two optical units 3 is L, the following equations (1) and (2) stand.

Y=X·tan α (1)

Y=(L−X)·tan β (2)

wherein, X and Y represent the pointed position coordinates of the position pointing device 2.

When X is found by using the above equations (1) and (2), the following equation (3) stands.

X=(L·tan β)/(tan α+tan β) (3)

When the angles α and β are detected, the pointed coordinates (X, Y) of the position pointing device 2 on the position detecting surface 1 can be calculated by using these equations (1) and (3).

The above explanation is the method for transforming into the X-Y coordinate system the angle data when the position pointing device 2 is viewed from each optical unit 3. Generally, the arithmetic device is provided in the position detecting device, so that the coordinate transformation is intended to be conducted. However, such a simple coordinate transformation can also be calculated in a host computer connected to the position detecting device. In the case where the computer has an arithmetic device as in the majority of the recent personal computer which can conduct a high-speed floating-point calculation, the process becomes extremely simple by processing at the computer. As explained in the present specification, when the angle data can be obtained only by the hardware, the coordinate transformation process is conducted at the personal computer as a host device without providing the arithmetic device to the position detecting device, so that the whole cost performance may be improved. Therefore, in the present specification, the arithmetic device for the process of the coordinate transformation is not particularly explained as a part of the position detecting device.

As has been described in the foregoing, according to the invention, the pointed position can be obtained only by a simple hardware without a high-speed A/D converter or a high-speed arithmetic circuit, or a mass storage memory device.

The pointed position can also be obtained with higher resolution only by installing a simple low-pass filter circuit.

While the invention has been described in its preferred embodiments, it is to be understood that the words which have been used are words of description rather than limitation and that changes within the purview of the appended claims may be made without departing from the true scope of the invention as defined by the claims.

What is claimed is:

1. A position detecting device for detecting a pointed position of a position pointing device having a light emitting means or a shadow generating means, comprising:
a flat board having a position detecting area which defines a range where said position pointing device can be moved by an operator on said flat board; and
optical units disposed at least at two positions adjacent to said position detecting area of said flat board, and detecting said pointed position of said position pointing device by the principle of triangulation using light,
each of said optical units comprising:
a one-dimensional light receiving element array having a plurality of light receiving elements;
a sequential output circuit outputting sequentially an analog value of an output of said one-dimensional light receiving element array;
a clock circuit supplying a timing signal to said sequential output circuit;
an output level comparing circuit judging whether the output from said sequential output circuit is higher or lower than a predetermined voltage level, and converting said analog value into a digital timing signal; and
a variation timing measuring circuit for obtaining a variation timing of said output level comparing circuit,
said pointed position of said position pointing device being detected from the output of said variation timing measuring circuit of each of said optical units by obtaining an incident angle of light or shadow from said position pointing device to each of said optical units.

2. The position detecting device according to claim 1, in which said position pointing device has said light projecting means which projects the light directly or indirectly, said output level comparing circuit is provided so as to be sensitive to the incident light, and the output of said variation timing measuring circuit corresponds to said incident angle of the light.

3. The position detecting device according to claim 2, which further comprises a light source means provided adjacent to each of said optical units, and in which said position pointing device comprises a retroreflective means for retroreflecting the light from said light source means.

4. The position detecting device according to claim 1, which further comprises a light projecting frame which projects the light directly or indirectly provided to a peripheral portion of said position detecting area of said flat board, in which said position pointing device has an intercepting function for intercepting the light from said light projecting frame, in which said output level comparing circuit is provided to be sensitive to the incident shadow generated by said position pointing device, and in which the output of said variation timing measuring circuit corresponds to said incident angle of the shadow.

5. The position detecting device according to claim 4, which further comprises a light source means provided adjacent to each of said optical units, and in which said light projecting frame is a retroreflective frame for retroreflecting the light from said light source means.

6. The position detecting device according to claim 1, in which said variation timing measuring circuit is provided to detect both a start timing and an end timing of the light or the shadow to be detected, so that the center of said light or said shadow is calculated from both the timings.

7. The position detecting device according to claim 1, in which said variation timing measuring circuit repeatedly detects the light or the shadow to be detected, so that a plurality of the pointed positions are calculated.

8. The position detecting device according to claim 1, which further comprises a low-pass filter circuit provided between said sequential output circuit of said one-dimensional light receiving element array and said output level comparing circuit, and in which a measuring time resolution of said variation timing measuring circuit is set to be higher than a clock period of said clock circuit supplying said timing signal to said sequential output circuit.

9. A position detecting method in a position detecting device for detecting a pointed position of a position pointing device having a light emitting means or a shadow generating means, and having a flat board having a position detecting area which defines a range where said position pointing device can be moved by an operator on said flat board, and optical units disposed at least at two positions adjacent to said position detecting area of said flat board, and detecting said pointed position of said position pointing device by the principle of triangulation using light, said position detecting method comprising the steps of:
a light receiving element output extracting step for sequentially taking an output of a one-dimensional light receiving element array having a plurality of light receiving elements provided in each of said optical units;
an output level comparing step for judging whether the output taken at said light receiving element output extracting step is higher or lower than a predetermined voltage level, and converting said output into a digital timing signal; and
a variation timing measuring step for obtaining an output variation timing from said digital timing signal obtained at said output level comparing step,
said pointed position of said position pointing device being detected from the output at said variation timing measuring step through each of said optical units by obtaining an incident angle of light or shadow from said position pointing device to each of said optical units.

10. The position detecting method according to claim 9, in which said position pointing device projects the light directly or indirectly, said output level comparing step is set to be sensitive to the incident light, and the output at said variation timing measuring step corresponds to said incident angle of the light.

11. The position detecting method according to claim 10, which further comprises a light source means provided adjacent to each of said optical units, and in which said position pointing device comprises a retroreflective means for retroreflecting the light from said light source means.

12. The position detecting method according to claim 9, which further comprises a light projecting frame which projects the light directly or indirectly provided to a peripheral portion of said position detecting area of said flat board, in which said position pointing device intercepts the light from said light projecting frame, in which said output level comparing step is set to be sensitive to the incident shadow generated by said position pointing device, and in which the output at said variation timing measuring step corresponds to said incident angle of the shadow.

13. The position detecting method according to claim 12, which further comprises a light source means provided adjacent to each of said optical units, and in which said light projecting frame is a retroreflective frame for retroreflecting the light from said light source means.

14. The position detecting method according to claim 9, in which said variation timing measuring step detects both a start timing and an end timing of the light or the shadow to be detected, so that the center of said light or said shadow is calculated from both the timings.

15. The position detecting method according to claim 9, in which said variation timing measuring step repeatedly detects the light or the shadow to be detected, so that a plurality of the pointed positions are calculated.

16. The position detecting method according to claim 9, which further comprises a low-pass filtering step provided between said light receiving element output extracting step and said output level comparing step, and in which a measuring time resolution at said variation timing measuring step is set to be higher than a clock period of a clock circuit supplying a timing signal at said variation timing measuring step.
